(19) United States
(12) Patent Application Publication
(10) Pub. No.: US 2022/0374354 A1
(43) Pub. Date: Nov. 24, 2022

(54) LIVE-MIGRATION OF PINNED DIRECT MEMORY ACCESS PAGES TO SUPPORT MEMORY HOT-REMOVE

(71) Applicant: Intel Corporation, Santa Clara, CA (US)

(72) Inventors: Sridhar MUTHRASANALLUR, Bangalore (IN); Rajesh M. SANKARAN, Portland, OR (US)

(21) Appl. No.: 17/844,568

(22) Filed: Jun. 20, 2022

(51) Int. Cl. G06F 12/02

(52) U.S. Cl. CPC G06F 12/0284; G06F 2212/1032

(57) ABSTRACT

A system on chip (SoC) coupled to a memory can perform a hot-remove operation in a computer system. In a hot-remove operation, software (e.g., operating system) and hardware (e.g., memory controller and interconnect circuitry) components migrate memory content from one region to another target region in the memory. A peripheral device can have direct memory access (DMA) to a page in the region of memory that is being hot-removed. The interconnect circuitry can migrate the page to the target region while maintaining the peripheral device's direct access to the memory. Interconnect circuitry uses hardware mirroring in response to a write command to a memory address in the region being hot-removed. With hardware mirroring, the data is stored in two locations; the first location is the memory address in the region being moved, and the second location is a memory address in the target region.

### FIELD

Descriptions are generally related to memory management, and more particularly, descriptions are related to the migration of pinned memory pages.

### BACKGROUND

The operating system (OS) manages memory dynamically among applications, drivers, and OS processes in a computer system. The OS sometimes offloads the content of the memory to a storage unit, e.g., a hard drive or a disk. For example, when the running processes need more memory than the available memory in the system, the OS may swap out some memory pages to a disk. However, some memory pages are pinned down and never swapped out. For example, an input/output (IO) device can have direct memory access (DMA) to a memory page. The OS would pin that memory page to prevent disruption to the operation of the IO device.

To improve the performance, the OS sometimes moves the content of the memory from one region to another region. When the move is done at runtime, it is called a hot-remove. If the region that OS is moving contains pinned memory page(s), then the system is prone to error, e.g., losing data and disruption to the operation of peripheral devices with DMA to the pinned memory page, because the pinned pages are always in-play and active.

In one traditional approach, the OS attempt to locate all pinned memory pages to a region of memory that will never be hot-removed during the system lifetime, which decreases the size of physical memory available at runtime to other applications. In another approach, the OS does not allocate a special region for pinned pages, and it will decline a user request for a hot-remove of a region with pinned pages. In another example implementation, when establishing direct memory access to memory pages, the peripheral devices do not pin those pages. A page requester interface (PRI) mechanism of address translation services of the peripheral component interconnect express (PCIe) standard is an example implementation that allows devices to have direct memory access to memory pages without pinning those pages. However, using the PRI mechanism is resource-intensive, creating a barrier to implementation.

### BRIEF DESCRIPTION OF THE DRAWINGS

The following description includes discussion of figures having illustrations given by way of example of an implementation. The drawings should be understood by way of example, and not by way of limitation. As used herein, references to one or more examples are to be understood as describing a particular feature, structure, or characteristic included in at least one implementation of the invention. Phrases such as “in one example” or “in an alternative example” appearing herein provide examples of implementations of the invention and do not necessarily all refer to the same implementation. However, they are also not necessarily mutually exclusive.

FIG. 1 is a block diagram of an example of a system with an interconnect circuitry.

FIG. 2 is a block diagram of an example of a system with interconnect and peripheral devices coupled to multiple regions in memory.

FIG. 3A is a block diagram of an example of a system with a peripheral device having direct access to memory during memory migration.

FIG. 3B is a block diagram of an example of a system using a peripheral component interconnect express (PCIe) to connect a peripheral device to regions of memory during memory migration.

FIG. 4 is a flow diagram of an example of a process for a system implementing migration flow.

FIG. 5 is a flow diagram of an example of a process for a system implementing write flow during a hot-remove migration.

FIG. 6 is an example of a computing system that can implement the interconnect circuitry and migration flow.

Descriptions of certain details and implementations follow, including non-limiting descriptions of the figures, which may depict some or all examples, as well as other potential implementations.

### DETAILED DESCRIPTION

As described herein, interconnect circuitry can maintain direct memory access of peripheral devices to a region of memory while migrating the content of that region to another region. Moving a region of memory, the current region, to another region, the target region, during runtime can be referred to as hot-remove. A peripheral device can have direct memory access (DMA) to a page, the current page, in the current memory region. Hardware and software components of an interconnect, e.g., root complex, establish and manage the DMA of peripheral devices, and the operating system (OS) initiates and manages hot-remove. A race condition between the interconnect and the OS can occur during hot-remove, in which the interconnect writes in a memory location that the OS has already moved, or the OS overwrites the memory location used by a peripheral device.

In one example implementation, the operating system uses transactional memory to migrate the memory content from the current region to the target region. Transactional memory is the concurrency control mechanism for controlling access to shared memory in concurrent computing. Transactional memory instructions enable the OS to avoid overwriting the data that the peripheral device with DMA had written to the target destination. In one example implementation, hardware mirroring prevents data loss when the peripheral device with DMA stores data in a memory location already moved. The interconnect can mirror the write command from the peripheral device to two different locations in memory. The first location is in the current memory page, and the second location is in the target memory page that the OS allocates. For example, traditionally, a single PCIe write results in just one write to the memory, whereas a single PCIe write during memory hot-remove with hardware mirroring results in two identical writes to two different locations in memory. Transactional memory and hardware mirroring enable the OS to dynamically migrate pinned memory regions without stopping peripheral devices with DMA during the migration.

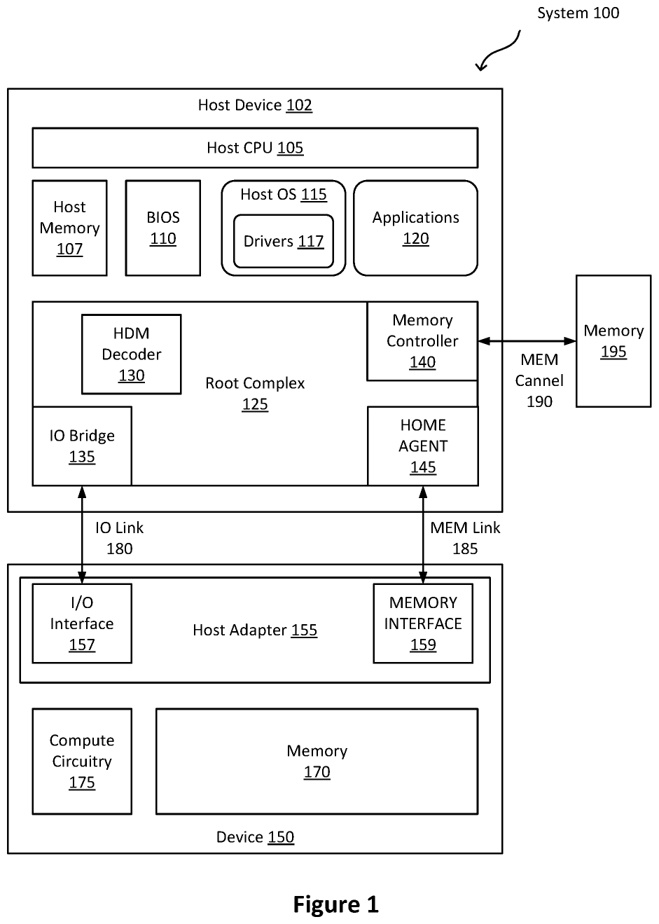

FIG. 1 is a block diagram of an example of a system with an interconnect circuitry. System 100 includes host device 102 coupled to device 150 via one or more compute express links (CXL). Host device 102 represents a host compute device such as a processor or a computing device. Device 150 includes memory 170, which can be made available to host device 102.

Host device 102 includes host central processing unit (CPU) 105 or other host processors to execute instructions and perform computations in system 100. Host device 102 includes basic input/output system (BIOS) 110, which can manage the memory configuration of host device 102. Host CPU 105 can execute host OS 115 and one or more host applications 120.

BIOS 110 can configure host OS 115 with memory configuration information. Memory configuration enables host OS 115 to allocate memory resources for different applications or workloads.

Host OS 115 can execute drivers 117, which represent device drivers to manage hardware components and peripherals in host device 102. Applications 120 represent software programs and processes in host device 102. Execution of applications 120 represents the workloads executed in host device 102. The execution of host OS 115 and applications 120 generates memory access requests.

System 100 includes main system memory 195, such as double data rate (DDR) type memory. Memory 195 represents volatile memory resources native to host device 102. In one example, memory 195 can be part of host device 102. Host device 102 couples to memory 195 via one or more memory (MEM) channels 190. Memory controller 140 of host device 102 manages access by the host device to memory 195. In one example, host device 102 includes host memory 107, such as a high bandwidth memory (HBM) or on-die memory.

In one example, memory controller 140 is part of host CPU 105 as an integrated memory controller. In one example, memory controller 140 is part of root complex 125, which generally manages memory access for host device 150. In one example, root complex 125 is part of host CPU 105, with components integrated onto the processor die or processor system on a chip. Root complex 125 can provide one or more communication interfaces for host CPU 105, such as peripheral component interconnect express (PCIe). In one example, root complex 125 is implemented in hardware. In one example, root complex 125 is implemented in software. In one example, root complex 125 has both hardware and software components. Herein, root complex 125 is also referred to as the interconnect or PCIe block.

In one example, host device 102 includes root complex 125 to couple with device 150 through one or more links or network connections. Memory (MEM) link 185 represents an example of a CXL memory transaction link or CXL.mem transaction link. IO (input/output) link 180 represents an example of a CXL input/output (IO) transaction link or CXL.io transaction link. In one example, root complex 125 includes home agent 145 to manage memory link 185. In one example, root complex 125 includes IO bridge 135 to manage IO link 180.

IO bridge 135 can include an IO memory management unit (IOMMU) to manage communication with device 150 via IO link 180. In one example, root complex 125 includes host-managed device memory (HDM) decoders 130 to provide a mapping of host to device physical addresses for use in system memory (e.g., pooled system memory). Herein, the device physical address can also be referred to as the guest physical address.

In one example, device 150 includes host adapter 155, which represents adapter circuitry to manage the links with host device 102. Device 150 can include memory 170 as a device memory, which can be memory resources provided to host device 102. Device 150 can include compute circuitry 175, which can be compute circuitry to manage device 150 and provide memory compute offload for host device 102.

Host adapter 155 includes memory interface 159 as memory transaction logic to manage communication with elements of root complex 125, such as home agent 145, via memory link 185. Host adapter 155 includes IO interface 157 to manage communication with elements of root complex 125, such as IO bridge 135, via IO link 180. In one example, host adapter 155 can be integrated with compute circuitry, being on the same chip or die as the compute circuitry. In one example, host adapter 155 is separate from compute circuitry 175. In one example, memory interface 159 and IO interface 157 can expose portions of device memory 170 to host device 102.

In one example, root complex 125 provides direct memory access to device 150. Direct memory access allows device 150 to send or receive data directly to or from memory 195. Host CPU 105 is not involved in device 150 DMA to memory 195. In one example, root complex 125 includes a hardware interface to couple to memory 195, e.g., memory controller 140. In one example, root complex 125 includes circuitry to establish and maintain direct access to memory for device 150. In one example, root complex 125 is implemented on a circuit chip.

In one example, host OS 115 allocates and manages system resources, including host CPU 105 processing cycles and memory 195. In one example, host OS 115 initiates and participates in moving memory contents from one region to another. In one example, host OS 115 initiates and participates in offloading memory contents to another memory or a storage device, e.g., memory 170, a hard drive, or a storage disk. In one example, host OS 115 triggers and participates in hot-remove where host OS 115 and hardware components such as root complex 125 and memory controller 140 migrate memory contents from one region to another during the runtime and without interrupting device 150 direct memory access to memory 195.

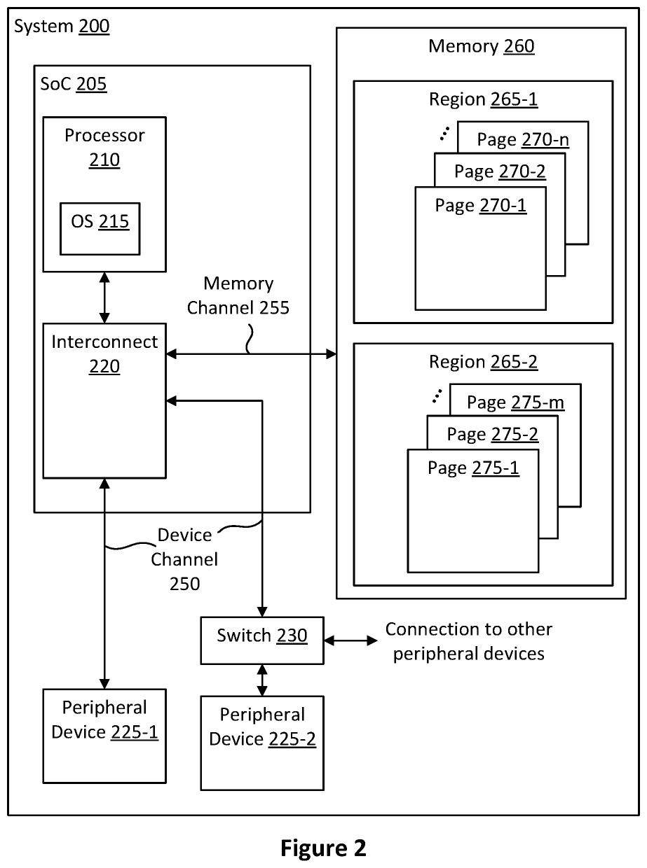

FIG. 2 is a block diagram of an example of a system 200 with interconnect 220 and peripheral devices 225-1 and 225-2, collectively referred to as devices 225, communicatively coupled to regions region 265-1 and 265-2, collectively referred to as regions 265, in memory 260. System 200 includes system on chip (SoC) 205, memory 260, switch 230, and peripheral devices 225. In one example, SoC 205 includes processor 210 and interconnect 220. In one example, SoC 205 is a multi-die package that could include one or more memory dies, e.g., high bandwidth memory (HBM). In one example, processor 210 includes one or more central processing units (CPU), one or more graphical processing units (GPU), or a combination of CPUs and GPUs, where each CPU or GPU could have one or more cores.

In one example, peripheral devices 225 are directly coupled with interconnect 220 of SoC 205, e.g., peripheral device 225-1 through device channel 250. In another example, peripheral devices 225, e.g., peripheral device 225-2, are coupled with interconnect 220 of SoC 205 via switch 230 and device channel 250. In one example, switch 230 is implemented in hardware. In another example, switch 230 is a virtual switch implemented as a combination of hardware or software. In another example, switch 230 is implemented in software.

In one example, memory 260 includes one or more regions, e.g., region 265-1 and region 265-2. Each region 265 of memory 260 includes multiple memory pages. For example, region 265-1 includes n memory pages, i.e., page 270-1, page 270-2, . . . , and page 270-n. Similarly, region 265-2 includes m memory pages, i.e., page 275-1, page 275-2, . . . , and page 275-m.

In one example, interconnect 220 is communicatively coupled with peripheral devices 225 via device channel 250 and communicatively coupled with memory 260 via memory channel 255. Interconnect 220 is capable of providing direct memory access to peripheral devices 225. In one example, when a peripheral device, e.g., peripheral device 225-1, has direct memory access to a memory page, e.g., page 270-1, OS 215 would pin that page. A pinned memory page is accessible by both SoC 205 and the peripheral device with direct memory access to that page.

In one example, OS 215 and interconnect 220 perform hot-remove of a memory region. For example, OS 215 and interconnect 220 move the content of region 265-1 to region 265-2. In another example, OS 215 and interconnect 220 perform a hot-remove of a memory region, e.g., region 265-1, containing a pinned page, e.g., page 270-1. In one example, interconnect 220 provides a peripheral device, e.g., peripheral device 225-1, direct memory access to a memory page, e.g., page 270-1. OS 215 pins page 270-1 due to peripheral device 225-1 direct access. OS 215 and interconnect 220 perform a hot-remove of memory region 265-1, containing pinned page 270-1 while maintaining the direct access of peripheral device 225-1 to memory 260. In one example, peripheral device 225 with direct access to memory 260 is an input/output (IO) device, and the corresponding pinned page in the memory is an IO DMA page.

In one example, interconnect 220 implements transaction memory instructions to hot-remove and migrate data. In one example, OS 215 and interconnect 220 implement transaction memory instructions to hot-remove data from one region.

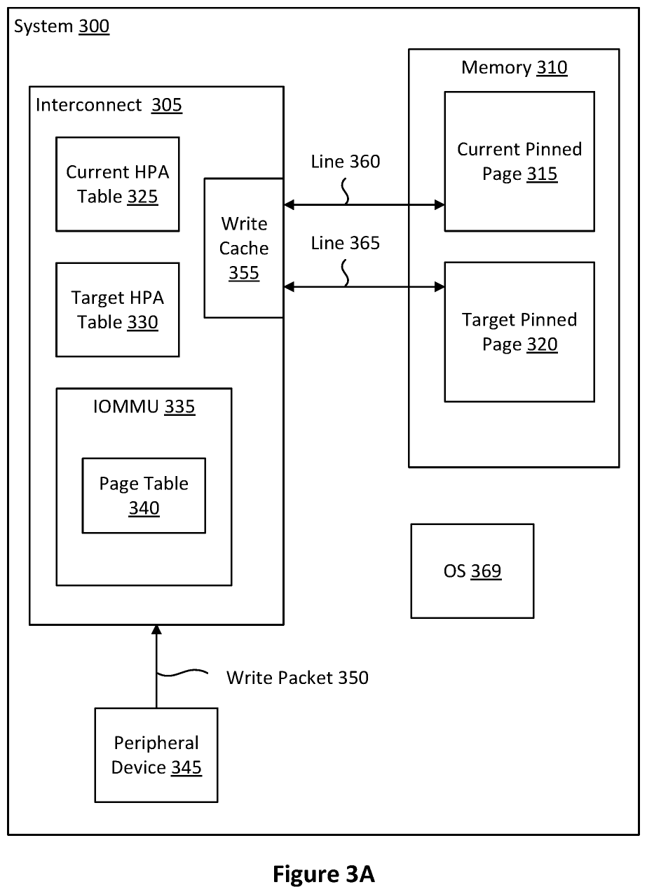

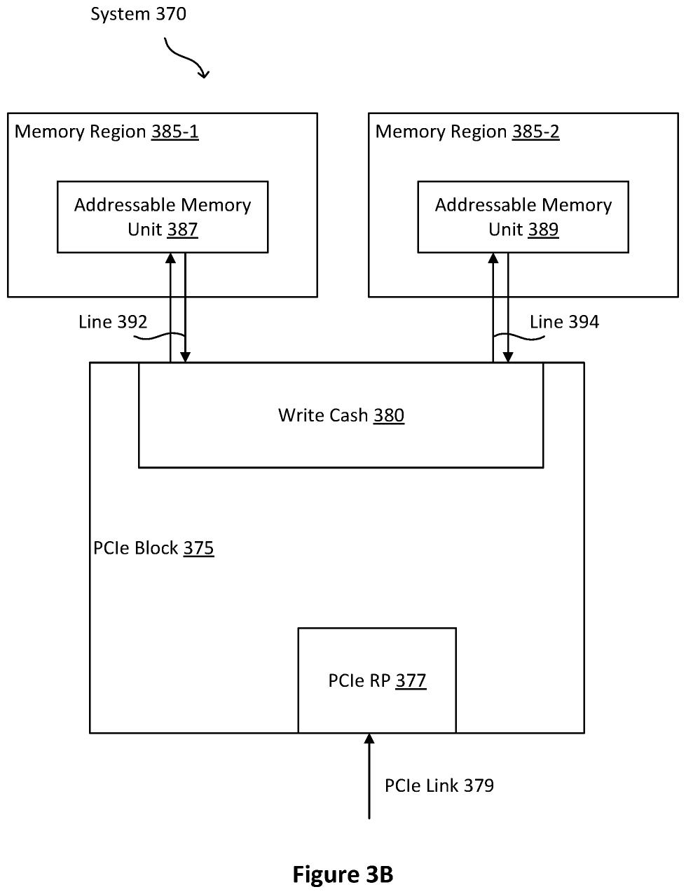

FIG. 3A is a block diagram of an example of a system 300 with peripheral device 345 having direct access to memory 310 during memory migration. System 300 includes interconnect 305, memory 310, and peripheral device 345. In one example, peripheral device 345 has direct access to current pinned page 315 in memory 310 through interconnect 305. To store data in memory 310, peripheral device 345 sends write packet 350 to interconnect 305. Write packet 350 includes a memory address and data to be stored. The memory address used by peripheral device 345 can be referred to as the guest physical address (GPA) or the device physical address.

In one example, peripheral devices, e.g., device 345, use guest physical addresses to access the memory available to them. For example, OS 369 allocates virtual memory, a subset of memory 310, to device 345. To access the allocated memory, device 345 uses guest physical addresses different from the host physical address used by OS 369. Host physical addresses are the addresses used by OS 369 and the system's memory controller to index memory 310 and access addressable memory units in memory 310. In one example, to access memory 310, device 345 GPA must be translated into an HPA.

In one example, interconnect 305 includes IO memory management unit (MMU) 335 and page table 340. Page table 340 includes the guest physical address used by peripheral device 345 and host physical address of the memory page to which device 345 has DMA, i.e., current pinned page 315. Page table 340 translates guest physical addresses (GPA) (or device physical address) to host physical addresses (HPA). In one example, OS 369 and interconnect 305 update IOMMU page table 340 by replacing the HPA of IOMMU page table 340 entries with the HPA of target pinned page 320.

When peripheral device 345 sends a write packet 350, interconnect 305 receives the write packet 350. Page table 340 of IOMMU 335 receives the guest memory address in the write packet 350 and generates the host physical address. The host physical address indicates the physical location in memory 310, where the data in write packet 350 will be stored. The write cache 355 of interconnect 305 receives the host physical address and data and stores the data in the memory. When peripheral device 345 has DMA to memory 310, the host physical addresses are in one or more pinned pages, e.g., current pinned page 315 in FIG. 3.

In one example, interconnect 305 includes current HPA table 325. Current HPA table 325 includes the host physical addresses of current pinned page 315 in memory 310 that OS 369 has allocated to peripheral device 345. Through the hot-remove operation, OS 369 and interconnect 305 would move the memory contents in current pinned page 315 to target pinned page 320 in memory 310.

In one example, interconnect 305 includes target HPA table 330. Target HPA table 330 contains the host physical addresses of target pinned page 320. In one example, OS 369 allocates target pinned page 320 for hot-removing current pinned page 315, and programs target HPA table 330 with the physical addresses of target pinned page 320. In one example, there is an association between entries of current HPA table 325 and entries in target HPA table 330. Thus, an address in current HPA table 325 is associated with an address in target HPA table 330. Runtime migration of data during hot-removal of a pinned page can include moving data from an address in current HPA table 325 to the associated address in target HPA table 330.

In one example, OS 369 and interconnect 305 update page table 340 of IOMMU 335. OS 369 and interconnect 305 update page table 340 by replacing the values of host physical addresses in page table 340 with the values of HPA of target pinned page 320, i.e., values of target HPA table 330.

In one example, interconnect 305 implements hardware mirroring when it receives write packet 350 during migrating contents of current pinned page 315 to target pinned page 320. Write cache 355 receives two host physical addresses. The first HPA is from current HPA table 325, identifying an addressable memory unit on current pinned page 315. The second HPA is from target HPA table 330, identifying an addressable memory unit on target pinned page 320. In one example, the interconnect 305 establishes line 360 to current pinned page 315 to write data in the first HPA from current HPA table 325. Interconnect 305 establishes line 365 to target pinned page 320 to write data in the second HPA from target HPA table 330. In one example, OS 369 and interconnect 305 implement transactional memory instruction to migrate contents of current pinned page 315 to target pinned page 320 during the hot-remove procedure.

In one example, current HPA table 325, target HPA table 330, and page table 340 are implemented using a plurality of registers. In one example, current HPA table 325, target HPA table 330, and page table 340 are implemented using highspeed internal memory, including static random access memory (SRAM) or scratch memory.

FIG. 3B is a block diagram of an example of system 370 using peripheral interconnect express (PCIe) to connect peripheral devices to regions of memory during memory migration. PCIe block 375 is herein referred to as interconnect or root complex. PCIe block 375 can be implemented in a combination of hardware and software. The software component of PCIe includes a PCIe protocol. In one example, the software component could include a CXL protocol. PCIe's software component includes a PCIe protocol that defines the management of a link with messages compatible with a standard or custom implementation of PCIe. Similarly, the software component of CXL includes a CXL protocol that defines management compatible with a standard or custom implementation of CXL.

In one example, the peripheral devices are communicatively coupled with PCIe block 375 through PCIe link 379. When a device sends a write packet, the PCIe root port (RP) 377 receives the memory write packet on PCIe link 379. PCIe RP 377 is also known as PCIe root port, which is a port on the root complex that allows PCIe block 375 to communicate with the peripheral devices, e.g., IO bridge 135 in FIG. 1. The write packet contains data and the memory address where the data will be stored. In one example, PCIe block 375 gains coherence ownership of a line to the memory address by issuing an internal RdOwnNoData (or RdOwn) command on its coherent interface. Coherence ownership of a line to a memory address is an exclusive access that prevents any other access to that memory address. Coherence ownership can be referred to as coherent access. Once ownership is obtained, PCIe block 375 can write the data from the original memory write (MWr) packet in its internal write cache 380.

In one example, PCIe block 375 receives a memory write (MWr) packet at PCIe RP 377 to store data in addressable memory unit 387 in memory region 385-1 during migration of memory region 385-1 to memory region 385-2. In one example, PCIe block 375 gains coherence ownership of line 392 and line 394 by issuing two internal RdOwnNoData (or RdOwn) commands in its coherent interface.

In one example, each of line 392 and line 394 include two one-directional communication links: one communication link taking information from PCIe block 375 to the memory, and one communication link taking information from memory to PCIe block 375, carrying data and PCIe protocol signaling and messages. Once ownership is obtained, PCIe block 375 writes the data from the original memory write (MWr) packet in its internal write cash (Wr$) to two addresses for addressable memory unit 387 and addressable memory unit 389.

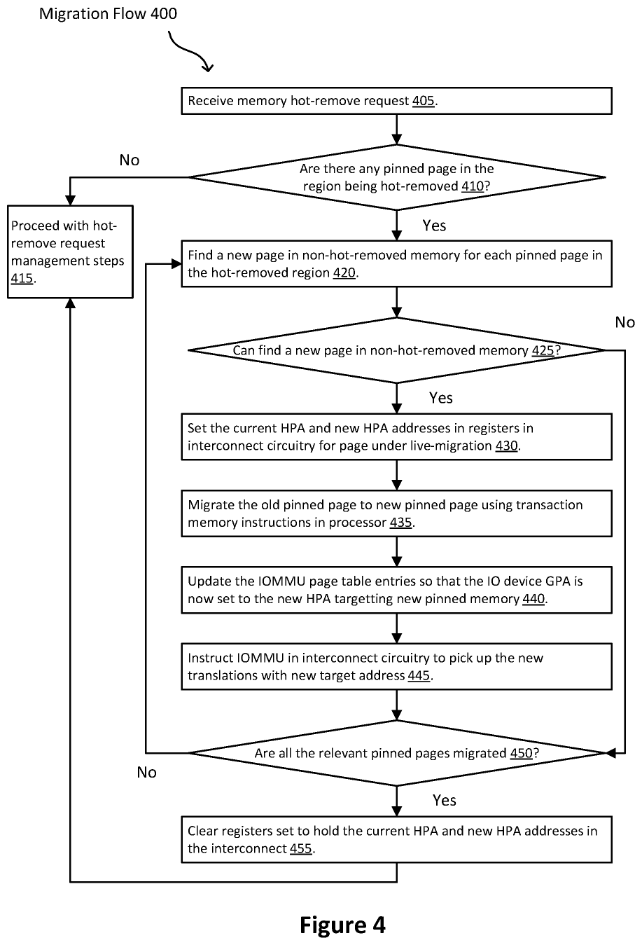

FIG. 4 is a flow diagram of an example of a process for a system implementing migration flow 400. In one example described in box 405, migration flow 400 receives a request for memory hot-remove, i.e., migrating one memory region to another. In one example, the operating system initiates the hot-remove request.

In one example described in box 410, the migration flow 400 checks whether there is any pinned page in the region being hot-removed. In one example, a page is pinned in memory when a peripheral device has direct memory access to that page. In one example, if there is no pinned page in the region being hot-removed, then the migration flow 400 proceeds with typical hot-remove management operations as described in box 415. In one example, the operating system and memory controller perform the typical hot-remove management operations and copy the contents of one memory region to another. In one example, migration flow 400 moves on to the operation described in box 420 if there are pinned pages in the region being hot-removed.

In one example described in box 420, flow 400 enters a loop to migrate each pinned page in the hot-removed region. In one example, the operating system allocates a new page, in the non-hot-removed memory region, for each pinned page in the hot-removed region.

In one example described in box 425, if a new page in non-hot-removed memory is unavailable, migration flow 400 moves on to perform the operation described in box 450. In one example described in box 450, migration flow 400 checks whether the OS and interconnect circuitry have migrated all the relevant pinned pages in the hot-remove region. In one example, if there are still pinned pages in the hot-remove region that the OS and the interconnect circuitry have not migrated, migration flow 400 returns to find a new page in non-hot-removed memory to migrate the remaining pinned pages, as described in box 420.

In one example described in box 425, if the operating system finds and allocates a new page in non-hot-removed memory to migrate a pinned page in hot-removed memory, flow 400 moves on to perform the operation described in box 430. In one example described in box 430, the operating system sets the current host physical addresses and new host physical addresses in interconnect circuitry. In one example, the interconnect circuitry includes registers to store the current host physical addresses, and the operating system sets these registers with the value of physical addresses of the pinned page being migrated. In one example, the interconnect circuitry includes registers to store the new host physical addresses, and the operating system sets these registers with the value of the physical address of the page allocated in the non-hot-removed region for migrating the pinned page in the hot-remove region. Migration flow 400 moves on to perform the operations described in box 435.

In one example described in box 435, the OS and interconnect circuitry migrate the old pinned page to the new pinned page using transaction memory instructions in the processor. The old pinned page is the pinned page in the hot-removed region, and the new page is the page in the non-hot-removed region that the OS has allocated. Migration flow 400 moves on to perform the operations described in box 440.

In one example described in box 440, the OS updates the IOMMU page table entries in interconnect circuitry so that the IO device guest physical address is set to the new HPA targeting new pinned memory. The peripheral device with direct memory access to a pinned page uses guest physical address to access the pinned page in memory. In one example, the IOMMU page table is a table stored in interconnect and translates the guest physical addresses to host physical addresses. In one example, when the OS moves the old pinned page in the hot-removed region to the new pinned page in the non-hot-removed region, the guest physical address used by the peripheral device does not change. Thus, the OS can update the IOMMU page table to translate the guest physical addresses to host physical addresses in the new pinned page in the non-hot-removed region. Migration flow 400 moves on to perform the operations described in box 445, in which the OS instructs IOMMU in interconnect circuitry to implement the new translation with the new target address of the pinned page in the non-hot-removed region.

Migration flow 400 moves on to perform the operations described in box 450. In one example described in box 450, the OS reviews and checks whether all the relevant pinned pages are migrated. In one example, if there are still relevant pinned pages that OS has to migrate, migration flow 400 returns to perform the operation in box 420. In one example, if the OS and interconnect circuitry have moved all relevant pinned pages, migration flow 400 moves on to perform the operation in box 455.

In one example described in box 455, the operating system clears registers set to hold the current host physical addresses and new host physical addresses in the interconnect circuitry. At this point, all the relevant pinned pages are hot-removed to new locations in non-hot-removed regions of memory. Migration flow moves on to perform the operations described in box 415, i.e., migrating the pages in the hot-remove regions that are not in any pinned pages.

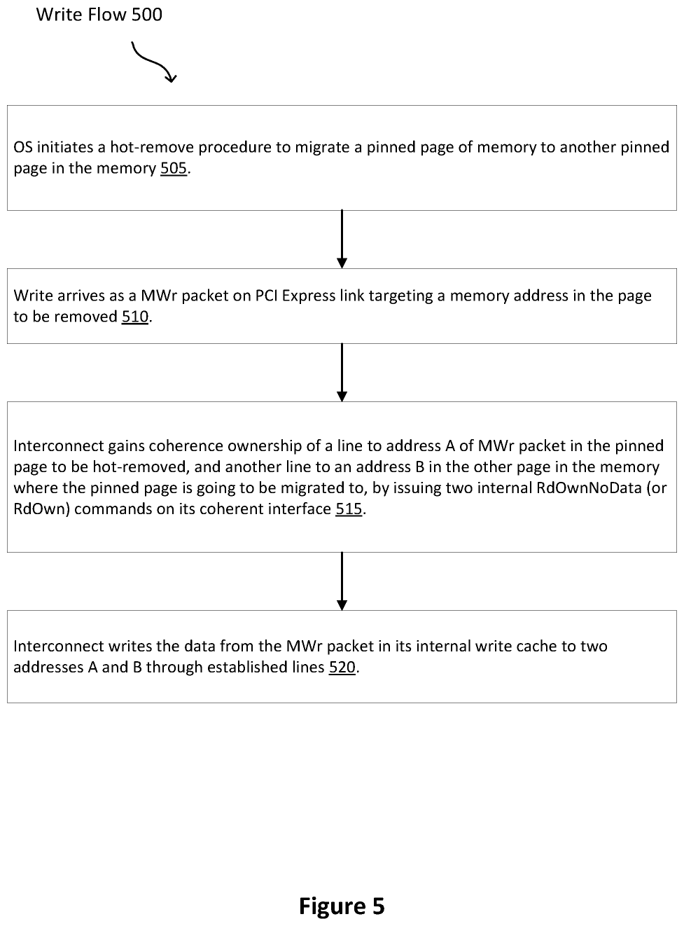

FIG. 5 is a flow diagram of an example of a process for a system implementing write flow 500 during a hot-remove migration. In one example described in box 505, the OS has initiated a hot-removed procedure to migrate a pinned page of memory as part of the hot-remove migration of a memory region to another. In one example described in box 510, a write command arrives at the interconnect circuitry while migrating the pinned page. In one example, the write command arrives as a memory write (MWr) packed on the PCIe link. In one example, the write command includes data and memory address to store the data. In one example, the memory address is in the pinned page, which the OS and interconnect circuitry are migrating. Write flow 500 moves on to perform the operation described in box 515.

In one example described in box 515, the interconnect circuitry performs hardware mirroring. The interconnect circuitry performs hardware mirroring by establishing exclusive access to two memory addresses. The interconnect circuitry gains coherence ownership of a line to the memory address in the memory write packet (MWr) that arrived on the PCIe link, denoting this address as address A. The OS and interconnect will move the content of address A to a memory address in a pinned page in a non-hard-remove region of memory, denoting this address as address B. The interconnect circuitry gains coherence ownership of a line to the memory address B. In one example, the interconnect gains coherence ownership of a line by issuing an internal RdOwnNoData (or RdOwn) command on its coherent interface. Write flow 500 moves on to perform the operations described in box 520, where the interconnect circuitry writes the data from the memory write (MWr) packet in its internal write cache to two addresses, A and B, through the established lines.

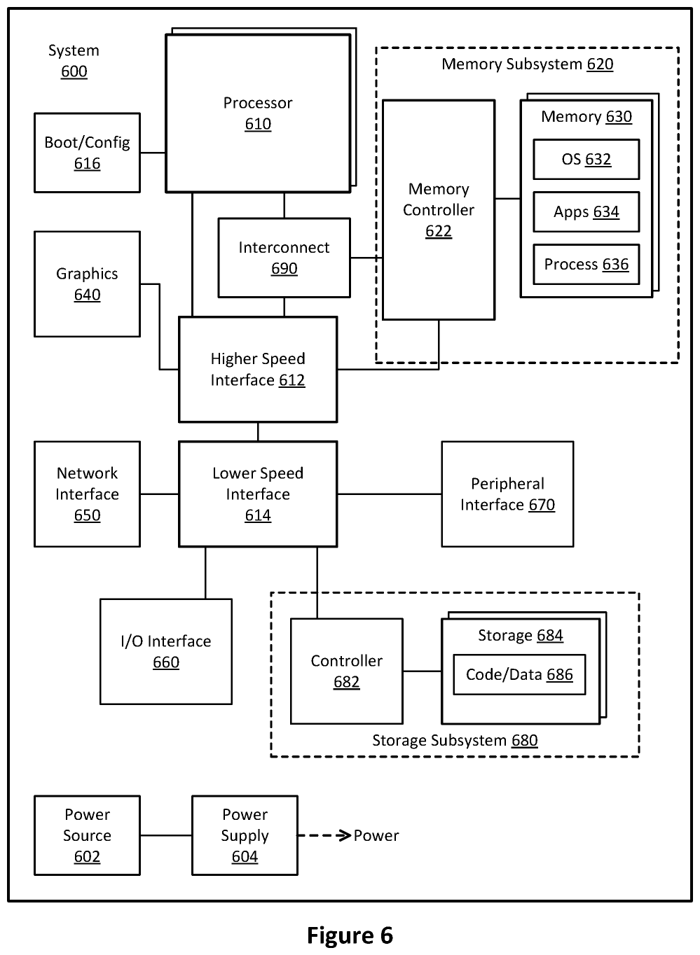

FIG. 6 is a block diagram of an example of a computing system that can hot-remove pinned pages of memory during runtime without causing any disruption in direct memory access to pinned pages. System 600 represents a computing device in accordance with any example herein and can be a laptop computer, a desktop computer, a tablet computer, a server, a gaming or entertainment control system, an embedded computing device, or other electronic devices.

In one example, the hardware components of system 600 are made on one die. In one example, the hardware components of system 600 are made on more than one die. In one example, multiple dies implementing components of system 600 are in one package, i.e., a multi-die package. In one example, system 600 includes a system on chip. In one example, a system on chip can include processor 610, interconnect 690, high speed 612 and low speed 614 interfaces, graphics 640, network interface 650, and memory subsystem 620. In one example, hardware components of system 600 are manufactured based on a tile architecture. In one example of a tile architecture, each tile is a die that can implement one or more components of system 600.

In one example, system 600 includes OS 632 and interconnect 690 to perform hot-remove migration of memory contents from one memory region containing pinned memory pages to another memory region. OS 632 and interconnect 690 use transactional memory instructions of processor 610 to move pinned pages in the hot-remove memory region to pinned pages in the non-hot-removed memory region. OS 632 and interconnect 690 also implement hardware mirroring to execute memory write commands for storing data in pinned memory pages during hot-remove migration. In one example, interconnect 690 is part of processor 610. In one example, interconnect 690 is part of higher speed interface 612.

System 600 includes processor 610 can include any type of microprocessor, central processing unit (CPU), graphics processing unit (GPU), processing core, or other processing hardware, or a combination, to provide processing or execution of instructions for system 600. Processor 610 can be a host processor device. Processor 610 controls the overall operation of system 600 and can be or include one or more programmable general-purpose or special-purpose microprocessors, digital signal processors (DSPs), programmable controllers, application specific integrated circuits (ASICs), programmable logic devices (PLDs), or a combination of such devices.

System 600 includes boot/config 616, which represents storage to store boot code (e.g., basic input/output system (BIOS)), configuration settings, security hardware (e.g., trusted platform module (TPM)), or other system level hardware that operates outside of a host OS (operating system). Boot/config 616 can include a nonvolatile storage device, such as read-only memory (ROM), flash memory, or other memory devices.

In one example, system 600 includes interface 612 coupled to processor 610, which can represent a higher speed interface or a high throughput interface for system components that need higher bandwidth connections, such as memory subsystem 620 or graphics interface components 640. Interface 612 represents an interface circuit, which can be a standalone component or integrated onto a processor die. Interface 612 can be integrated as a circuit onto the processor die or integrated as a component on a system on a chip. Where present, graphics interface 640 interfaces to graphics components for providing a visual display to a user of system 600. Graphics interface 640 can be a standalone component or integrated onto the processor die or system on a chip. In one example, graphics interface 640 can drive a high definition (HD) display or ultra high definition (UHD) display that provides an output to a user. In one example, the display can include a touchscreen display. In one example, graphics interface 640 generates a display based on data stored in memory 630 or based on operations executed by processor 610, or both.

Memory subsystem 620 represents the main memory of system 600 and provides storage for code to be executed by processor 610 or data values to be used in executing a routine. Memory subsystem 620 can include one or more varieties of random-access memory (RAM) such as DRAM, 3DXP (three-dimensional crosspoint), or other memory devices, or a combination of such devices. Memory 630 stores and hosts, among other things, operating system (OS) 632 to provide a software platform for executing instructions in system 600. Additionally, applications 634 can execute on the software platform of OS 632 from memory 630. Applications 634 represent programs with their own operational logic to execute one or more functions. Processes 636 represent agents or routines that provide auxiliary functions to OS 632 or one or more applications 634 or a combination. OS 632, applications 634, and processes 636 provide software logic to provide functions for system 600. In one example, memory subsystem 620 includes memory controller 622, which is a memory controller to generate and issue commands to memory 630. It will be understood that memory controller 622 could be a physical part of processor 610 or a physical part of interface 612. For example, memory controller 622 can be an integrated memory controller, integrated onto a circuit with processor 610, such as integrated onto the processor die or a system on a chip.

While not explicitly illustrated, it will be understood that system 600 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a HyperTransport or industry standard architecture (ISA) bus, a small computer system interface (SCSI) bus, a universal serial bus (USB), or other buses, or a combination.

In one example, system 600 includes interface 614, which can be coupled to interface 612. Interface 614 can be a lower speed interface than interface 612. In one example, interface 614 represents an interface circuit, which can include standalone components and integrated circuitry. In one example, multiple user interface components, peripheral components, or both are coupled to interface 614. Network interface 650 provides system 600 the ability to communicate with remote devices (e.g., servers or other computing devices) over one or more networks. Network interface 650 can include an Ethernet adapter, wireless interconnection components, cellular network interconnection components, USB (universal serial bus), or other wired or wireless standards-based or proprietary interfaces. Network interface 650 can exchange data with a remote device, which can include sending data stored in memory or receiving data to be stored in memory.

In one example, system 600 includes one or more input/output (I/O) interface(s) 660. I/O interface 660 can include one or more interface components through which a user interacts with system 600 (e.g., audio, alphanumeric, tactile/touch, or other interfacings). Peripheral interface 670 can include any hardware interface not specifically mentioned above. Peripherals refer generally to devices that connect dependently to system 600. A dependent connection is one where system 600 provides the software platform or hardware platform or both on which operation executes and with which a user interacts.

In one example, system 600 includes storage subsystem 680 to store data in a nonvolatile manner. In one example, in certain system implementations, at least certain components of storage 680 can overlap with components of memory subsystem 620. Storage subsystem 680 includes storage device(s) 684, which can be or include any conventional medium for storing large amounts of data in a nonvolatile manner, such as one or more magnetic, solid state, NAND, 3DXP, or optical based disks, or a combination. Storage 684 holds code or instructions and data 686 in a persistent state (i.e., the value is retained despite interruption of power to system 600). Storage 684 can be generically considered to be a “memory,” although memory 630 is typically the executing or operating memory to provide instructions to processor 610. Whereas storage 684 is nonvolatile, memory 630 can include volatile memory (i.e., the value or state of the data is indeterminate if power is interrupted to system 600). In one example, storage subsystem 680 includes controller 682 to interface with storage 684. In one example, controller 682 is a physical part of interface 614 or processor 610 or can include circuits or logic in both processor 610 and interface 614.

Power source 602 provides power to the components of system 600. More specifically, power source 602 typically interfaces to one or multiple power supplies 604 in system 600 to provide power to the components of system 600. In one example, power supply 604 includes an AC to DC (alternating current to direct current) adapter to plug into a wall outlet. Such AC power can be renewable energy (e.g., solar power) power source 602. In one example, power source 602 includes a DC power source, such as an external AC to DC converter. In one example, power source 602 or power supply 604 includes wireless charging hardware to charge via proximity to a charging field. In one example, power source 602 can include an internal battery or fuel cell source.

Examples of hot-remove of pinned pages follow.

Example 1: an apparatus including a hardware interface to couple to a memory, the memory having a first region and a second region, and the hardware interface capable to establish a direct access to the memory for a peripheral device coupled to the memory; circuitry capable to: migrate a page from the first region to the second region, and maintain the direct access to the memory by the peripheral device to the page during migration of the page from the first region to the second region.

Example 2: the apparatus of example 1, wherein the page is a pinned page in the first region of the memory.

Example 3: the apparatus of examples 1 or 2, wherein the page is a pinned input/output (IO) direct memory access (DMA) page in the first region of the memory.

Example 4: apparatus of any of examples 1-3, wherein the circuitry is capable to use transaction memory instructions to migrate data from the first region of the memory to the second region of the memory.

Example 5: the apparatus of any of examples 1-4, wherein the circuitry comprises a plurality of registers and the circuitry is to store in the plurality of registers host physical addresses of the page in the first region of the memory and host physical addresses of an other page in the second region of the memory.

Example 6: the apparatus of claim any of examples 1-5, wherein the circuitry is to connect the peripheral device to the memory, and an IO memory management unit (IOMMU) page table to translate a guest physical address of the peripheral device to a host physical address in the first region of the memory.

Example 7: the apparatus of any of examples 1-6, wherein the circuitry is to update the IOMMU page table, wherein update includes replacement of the host physical address of the first region of the memory with an other host physical address of the second region of the memory.

Example 8: the apparatus of any of examples 1-7, wherein the page comprises a first page, and wherein in response to a write command to store data in the first page in the first region, the circuitry capable to: gain a first access to the first page in the first region and a second access to a second page in the second region of the memory, and write data to the first page and the second page.

Example 9: the apparatus of any of examples 1-8, wherein the write command includes a peripheral component interconnect express (PCIe) memory write packet.

Example 10: the apparatus of any of examples 1-9, wherein the first access and the second access are coherent access.

Example 11: a computer system including: a peripheral device; and circuit chip comprising: a hardware interface to couple to a memory, the memory having a first region and a second region, and the hardware interface capable to establish a direct access to the memory for the peripheral device coupled to the memory; circuitry capable to: migrate a page from the first region to the second region, and maintain the direct access to the memory by the peripheral device to the page during migration of the page from the first region to the second region.

Example 12: the computer system of example 11, wherein the page is a pinned input/output (IO) direct memory access (DMA) page in the memory.

Example 13: the computer system of examples 11 or 12, wherein the circuitry to use transaction memory instructions to migrate data from the first region of the memory to the second region of the memory.

Example 14: the computer system of any of examples 11-13, wherein the circuitry comprising a plurality of registers and the circuitry to store in the plurality of registers host physical addresses of the page in the first region of the memory and host physical addresses of another page in the second region of the memory.

Examples 15: the computer system of any of examples 11-14, wherein the circuitry to connect the peripheral device to the memory, and an IO memory management unit (IOMMU) page table to translate a guest physical address of the peripheral device to a host physical address in the first region of the memory.

Example 16: the computer system of any of examples 11-15, wherein the circuitry to update the IOMMU page table, wherein update to include replacement of the host physical address of the first region of the memory with an other host physical address of the second region of the memory.

Example 17: the computer system of any of examples 11-16, wherein in response to a write command to store data in the page in the first region, the circuitry capable to: gain a first access to the page in the first region and a second access to an other page in the second region of the memory, and write data to the page and the other page.

Example 18: the computer system of any of examples 11-17, wherein the write command includes a peripheral component interconnect express (PCIe) memory write packet.

Example 19: a method including: migrating a page from a first region of a memory to a second region of the memory, and maintaining a direct access to the memory by a peripheral device to the page during migration of the page from the first region to the second region.

Example 20: the method of example 19, including: receiving a write command to store data in the page; gaining a first access to the page in the first region of the memory and a second access to an other page in the second region of the memory; writing data to the page and the other page.

Flow diagrams, as illustrated herein, provide examples of sequences of various process actions. The flow diagrams can indicate operations to be executed by a software or firmware routine, as well as physical operations. A flow diagram can illustrate an example of the implementation of states of a finite state machine (FSM), which can be implemented in hardware and/or software. Although shown in a particular sequence or order, the order of the actions can be modified unless otherwise specified. Thus, the illustrated diagrams should be understood only as examples, and the process can be performed in a different order, and some actions can be performed in parallel. Additionally, one or more actions can be omitted; thus, not all implementations will perform all actions.

To the extent various operations or functions are described herein, they can be described or defined as software code, instructions, configuration, and/or data. The content can be directly executable (“object” or “executable” form), source code, or difference code (“delta” or “patch” code). The software content of what is described herein can be provided via an article of manufacture with the content stored thereon or via a method of operating a communication interface to send data via the communication interface. A machine-readable storage medium can cause a machine to perform the functions or operations described and includes any mechanism that stores information in a form accessible by a machine (e.g., computing device, electronic system, etc.), such as recordable/non-recordable media (e.g., read-only memory (ROM), random access memory (RAM), magnetic disk storage media, optical storage media, flash memory devices, etc.). A communication interface includes any mechanism that interfaces to any of a hardwired, wireless, optical, etc., medium to communicate to another device, such as a memory bus interface, a processor bus interface, an Internet connection, a disk controller, etc. The communication interface can be configured by providing configuration parameters and/or sending signals to prepare the communication interface to provide a data signal describing the software content. The communication interface can be accessed via one or more commands or signals sent to the communication interface.

Various components described herein can be a means for performing the operations or functions described. Each component described herein includes software, hardware, or a combination of these. The components can be implemented as software modules, hardware modules, special-purpose hardware (e.g., application-specific hardware, application-specific integrated circuits (ASICs), digital signal processors (DSPs), etc.), embedded controllers, hardwired circuitry, etc.

Besides what is described herein, various modifications can be made to what is disclosed and implementations of the invention without departing from their scope. Therefore, the illustrations and examples herein should be construed in an illustrative and not a restrictive sense. The scope of the invention should be measured solely by reference to the claims that follow.

What is claimed is:

1. An apparatus comprising:
a hardware interface to couple to a memory, the memory having a first region and a second region, and the hardware interface capable to establish a direct access to the memory for a peripheral device coupled to the memory;
circuitry capable to:
migrate a page from the first region to the second region, and
maintain the direct access to the memory by the peripheral device to the page during migration of the page from the first region to the second region.

2. The apparatus of claim 1, wherein the page is a pinned page in the first region of the memory.

3. The apparatus of claim 2, wherein the page is a pinned input/output (IO) direct memory access (DMA) page in the first region of the memory.

4. The apparatus of claim 1, wherein the circuitry is capable to use transaction memory instructions to migrate data from the first region of the memory to the second region of the memory.

5. The apparatus of claim 1, wherein the circuitry comprises a plurality of registers and the circuitry is to store in the plurality of registers host physical addresses of the page in the first region of the memory and host physical addresses of an other page in the second region of the memory.

6. The apparatus of claim 1, wherein
the circuitry is to connect the peripheral device to the memory, and
an IO memory management unit (IOMMU) page table is to translate a guest physical address of the peripheral device to a host physical address in the first region of the memory.

7. The apparatus of claim 6, wherein the circuitry is to update the IOMMU page table, wherein update includes replacement of the host physical address of the first region of the memory with an other host physical address of the second region of the memory.

8. The apparatus of claim 1, wherein the page comprises a first page, and wherein in response to a write command to store data in the first page in the first region, the circuitry capable to:
gain a first access to the first page in the first region and a second access to a second page in the second region of the memory, and
write data to the first page and the second page.

9. The apparatus of claim 8, wherein the write command includes a peripheral component interconnect express (PCIe) memory write packet.

10. The apparatus of claim 8, wherein the first access and the second access are coherent access.

11. A computer system comprising:
a peripheral device; and
a circuit chip comprising:
a hardware interface to couple to a memory, the memory having a first region and a second region, and the hardware interface capable to establish a direct access to the memory for the peripheral device coupled to the memory;
circuitry capable to:
migrate a page from the first region to the second region, and
maintain the direct access to the memory by the peripheral device to the page during migration of the page from the first region to the second region.

12. The computer system of claim 11, wherein the page is a pinned input/output (IO) direct memory access (DMA) page in the memory.

13. The computer system of claim 11, wherein the circuitry to use transaction memory instructions to migrate data from the first region of the memory to the second region of the memory.

14. The computer system of claim 11, wherein the circuitry comprising a plurality of registers and the circuitry to store in the plurality of registers host physical addresses of the page in the first region of the memory and host physical addresses of another page in the second region of the memory.

15. The computer system of claim 11, wherein
the circuitry to connect the peripheral device to the memory, and
an IO memory management unit (IOMMU) page table to translate a guest physical address of the peripheral device to a host physical address in the first region of the memory.

16. The computer system of claim 15, wherein the circuitry to update the IOMMU page table, wherein update to include replacement of the host physical address of the first region of the memory with an other host physical address of the second region of the memory.

17. The computer system of claim 11, wherein in response to a write command to store data in the page in the first region, the circuitry capable to:
gain a first access to the page in the first region and a second access to an other page in the second region of the memory, and
write data to the page and the other page.

18. The computer system of claim 17, wherein the write command includes a peripheral component interconnect express (PCIe) memory write packet.

19. A method comprising:
migrating a page from a first region of a memory to a second region of the memory, and
maintaining a direct access to the memory by a peripheral device to the page during migration of the page from the first region to the second region.

20. The method of claim 19, comprising:
receiving a write command to store data in the page;
gaining a first access to the page in the first region of the memory and a second access to an other page in the second region of the memory;
writing data to the page and the other page.
